(19) United States
(12) Patent Application Publication
(10) Pub. No.: US 2006/0145943 A1
(43) Pub. Date: Jul. 6, 2006

(54) Avatar control using a communication device

(76) Inventors: Mark Tarlton, Barrington, IL (US); Stephen Levine, Itasca, IL (US); Daniel Servi, Lincolnshire, IL (US); Robert Zurek, Antioch, IL (US)

Correspondence Address: MOTOROLA INC, 600 NORTH US HIGHWAY 45, ROOM AS437, LIBERTYVILLE, IL, 60048-5343, US

(21) Appl. No.: 11/366,290

(22) Filed: Mar. 2, 2006

Related U.S. Application Data
(62) Division of application No. 10/287,414, filed on Nov. 4, 2002.

(51) Int. Cl. G09G 5/00

(52) U.S. Cl. 345/2.3

(57) ABSTRACT

Methods in a wireless portable communication device for transmitting annotating audio communication with an image (100), for receiving annotating audio communication with an image (300, 400) are provided. The image may be attached manually or automatically based upon a pre-selected condition to the audio communication.

### FIELD OF THE INVENTION

The present inventions relate generally to communications, more specifically to providing message during communications, for example in wireless communication devices.

### BACKGROUND OF THE INVENTION

Avatars are animated characters such as faces, and are generally known. The animation of facial expressions, for example, may be controlled by speech processing such that the mouth is made to move in sync with the speech to give the face an appearance of speaking. A method to add expressions to messages by using text with embedded emoticons, such as:-) providing a smiley face, is also known. Use of an avatar with scripted behavior such that the gesture is predetermined to express a particular emotion or message is also known as disclosed in U.S. Pat. No. 5,880,731, Liles et al. These methods require a keyboard having full set of keys or multiple keystrokes to enable the desired avatar feature.

### BRIEF DESCRIPTION OF THE DRAWINGS

FIG. 1 is an exemplary flowchart of one aspect of the present inventions for transmitting an avatar communication.

FIG. 2 is an exemplary numeric keypad mapping of the present inventions.

FIG. 3 is an exemplary flowchart of another aspect of the present inventions based upon the audio communication characteristics.

FIG. 4 is an exemplary flowchart of another aspect of the present inventions for receiving an avatar communication.

FIG. 5 is an example of an avatar communication between two users.

FIG. 6 is an example of swapping avatars based on the user's preference.

### DETAILED DESCRIPTION OF THE PREFERRED EMBODIMENT(S)

The present inventions provide methods in an electronic communication device to control an attribute complimenting a primary message.

During a communication such as, but not limited to, a live conversation, voice mail and e-mail, between first and second users using first and second communication devices, respectively, the first user as a originator may annotate the communication by attaching an image, or an avatar, expressing his emotional state regarding the present topic of the communication, and may change the avatar to reflect his emotional state as the communication progresses. The second user, as a recipient using the second communication device, sees the avatar, which the first user attached, as he listens to the first user speaks, and sees the avatar change from one image to another as the first user changes the avatar during the conversation using the first communication device. The first user may attach an image from pre-stored images in the first communication device. To easily access images, the numeric keys of the first communication device may be assigned to pre-selected images in a certain order.

The first user may initially add an image identifying himself to the second user as he initiates a call to the second user. The image may be a picture of the first user, a cartoon character, or any depiction identifying the first user, which the first user chooses to attach. On the receiving end, the second user may simply view what the first user has attached as an identifier, or may attach his own image choice to identify the first user. For example, the first user attaches a picture of himself to identify himself to the second user as initiates a call; the second user, having identified the caller as the first user, switches the picture of the first user with a cartoon character, which the second user has pre-defined to be the first user.

As the first user carries on with the conversation, a visual attribute may be automatically attached by detecting the voice characteristics of the first user by the first communication device as it transmits the conversation. For example, the loudness of the first user's voice may be manifested as a change in the size of the image, and his voice inflection at the end of a sentence, indicating the sentence as a question, may be manifested with the image tilting to the side. For multiple speakers, the image representing the speaker may be automatically changed from one speaker to the next by recognizing the voice of the current speaker.

On the receiving end, the communication device of the second user recognizes that the communication with the first user, be it a live conversation, voice mail, or text message, is an annotated communication, and reproduces the communication appropriate for the communication device of the second user. That is, based on the capability of the communication device of the second user and/or based on his preference, an appropriate reproduction mode is selected. For example, if the first user initiates a call to the second user using an avatar but the communication device of the second user lacks the display capability or the second user wishes not to view the first user's avatar, then the communication is reproduced in a form of audio only in the second user's communication device.

If the communication from the first user is an annotated text message such as an e-mail message or Short Messages Service (“SMS”) message, the second user may simply view the text message along with the attached avatar, or if the second user's communication device is capable of text-to-speech conversion, the second user may listen to the message while viewing the avatar. The second user may also have the message reproduced only audibly by the text-to-speech conversion process with the annotation providing additional expression such as rising inflection at the end of a question and varied loudness based on emphasized words.

With a network involved in the communication between the first and second users, some of the tasks may be performed by the network. For example, the network may determine an appropriate form of the message reproduction based upon the knowledge of the capability of the receiving device, and may reformat the annotated message received from the transmitting device to make the annotated message compatible with the receiving device.

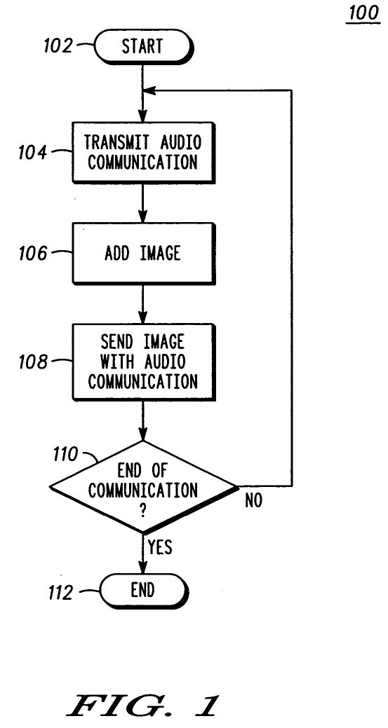

FIG. 1 is an exemplary flowchart of one aspect of the present inventions. A call is initiated from a first communication device of a first user in block 102, and the first user transmits audio communication in block 104. A recipient of the audio communication from the first user may be various entities such as, but not limited to, another party engaged in a live conversation with the first user, or a voice mail where the first user is leaving an audio message. While the first user is speaking, he may annotate the audio communication with an image by attaching an image to the audio communication in block 106. As the image is attached, it is transmitted along with the audio communication in block 108. The added image may be a visual attribute such as, but not limited to, an avatar, photographic image, cartoon character, or a symbol, effective in providing additional information complementing the audio communication. The additional information provided may be the first user's identification such as a photographic image of the first user, or different facial expressions conveying the emotion of the first user relative to the current topic of the audio communication. If the communication is terminated in block 110, the process ends in block 112. If the communication continues, the process repeats from block 106.

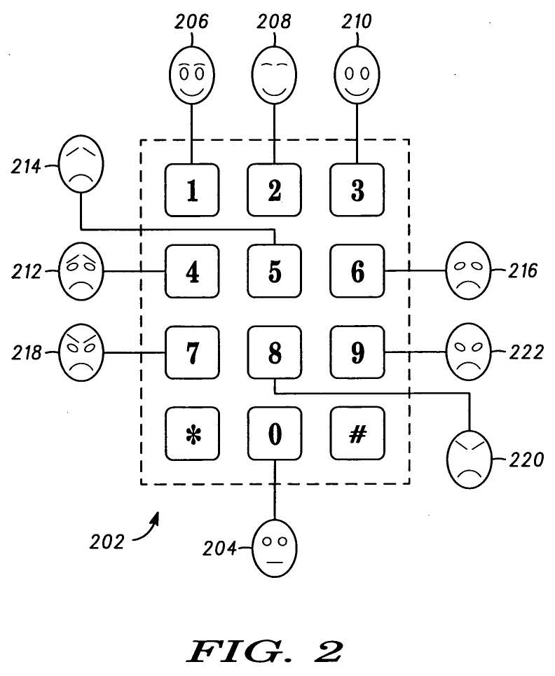

To easily attach an avatar to the communication, the keypad 202 of the first communication device may be programmed to have pre-selected avatars or images assigned to its input keys as shown in FIG. 2. In this example, each numeric key (keys corresponding to numbers from 0 to 9) of the keypad is assigned with an avatar such that it is easier for the first user to remember the type and degree of emotion he can select. For example, the numeric key 0 has a neutral expression 204 assigned; the first row of keys (numbers 1, 2, and 3) have happy expressions (206, 208, and 210) with decreasing level of happiness; the second row of keys (numbers 4, 5, and 6) have sad expressions (212, 214, and 216) with decreasing level of sadness; and the third row of keys (numbers 7, 8, and 9) have angry expressions (218, 220, and 222) with decreasing level of anger. Alternatively, a navigator button having multiple positions may be used in place of the keypad for pre-assigned avatars. The keypad and navigator button may be also used to complement each other by providing additional pre-selected expressions. An image assigned to an input key may be retrieved and attached to the audio communication by simply depressing the input key only once. To access more images, number of image may be stored in the memory of the first communication device, and a desired image may be retrieved through a menu or by a series of input key strokes.

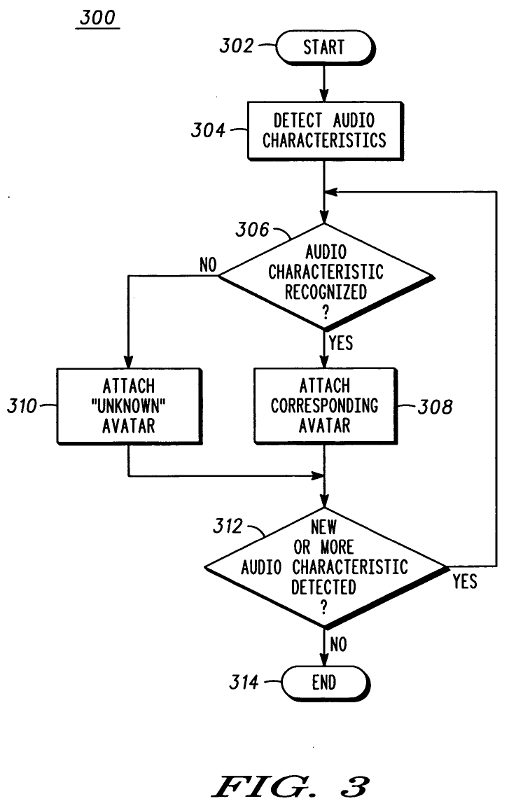

Instead of having the first user manually select an avatar from the pre-selected avatars, the first communication device may automatically select an avatar that is appropriate for the audio communication based upon the characteristics of the audio communication. FIG. 3 illustrates an exemplary flowchart of an aspect of the present inventions based upon the audio characteristics of the communication. As the first user begins to speak in block 302 transmitting audio communication, the first communication device detects an audio characteristic of the first user in block 304. If the first communication device recognizes the audio characteristic in block 306, then it attaches an avatar corresponding to the audio characteristic such as, but not limited to, the identification of the first user, in block 308. If the first communication device does not recognize the audio characteristic in block 306, then it attaches an avatar which indicates that the audio characteristic sought is unrecognized in block 310. For example, if the audio characteristic sought to detect was to identify the first user, then the displayed avatar would indicate that the first user is unrecognized. The first communication device then checks for a new audio characteristic or more of the same audio characteristic in block 312, and if there is a new or more of the audio characteristic detected, then the process is repeated from block 306. Otherwise, the process is terminated in block 314.

The audio characteristic to be determined may not be limited to the voice recognition. For example, the first communication device may recognize a spoken sentence as a question by detecting an inflection at the end of the sentence, and may attach an avatar showing a titling face having a quizzical expression. The first communication device may also detect the first user's loudness, and may adjust the size of the mouth of the avatar, or may make avatar more animated, or may detect a pre-selected word or phrase and display a corresponding or pre-assigned avatar based on the pre-selected word or phrase.

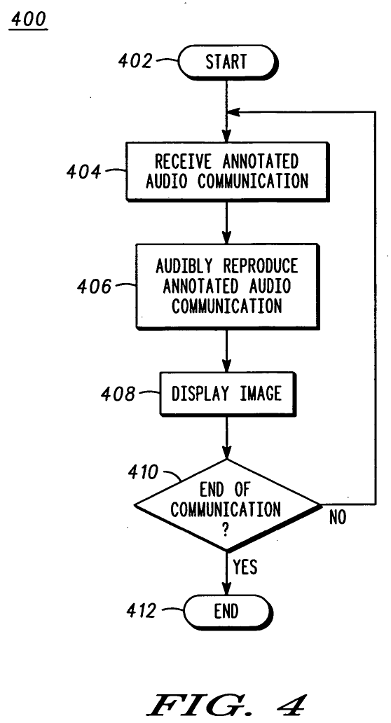

FIG. 4 is an exemplary flowchart of another aspect of the present inventions for receiving an avatar communication. As the second communication device of the second user receives a call from the first device of the first user in block 402, it first receives an annotated audio communication annotated with an image from the first communication device in block 404. The annotated audio communication may be, a live conversation, or voice mail. The second communication device then audibly reproduces the annotated audio communication in block 406, and then displays an image associated with the image annotated to the audio communication in block 408. In block 410, whether to terminate or to continue receiving the annotated audio communication is determined. If the communication is terminated in block 410, the process ends in block 412. If the communication continues, then the process repeats from block 404

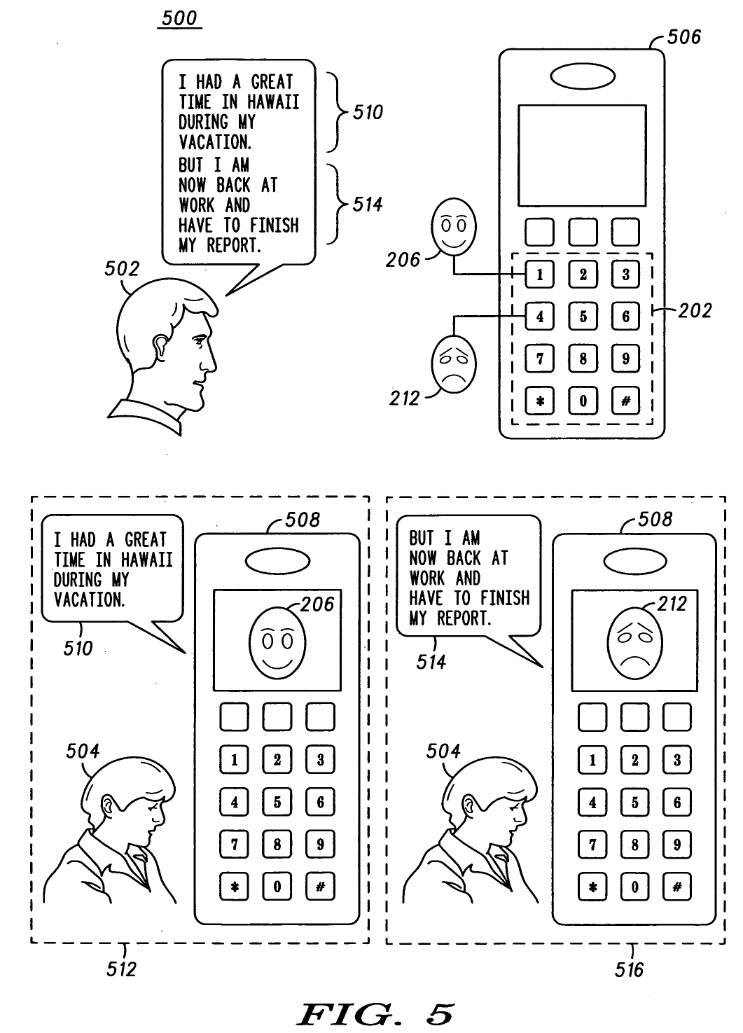

FIG. 5 illustrates an example of an annotated message communication 500 for a live conversation between the first 502 and second 504 users having the first 506 and second communication 508 devices, respectively. As the first user speaks about his vacation 510, he selects the numeric key 1 from the keypad 202 of FIG. 2 to attach the expression 206 (“very happy”). The second user on the second communication device observes the expression 206 as he hears about the first user's vacation 512. As the first user begins to talk about his work 514, he attaches the expression 212 (“very sad”) by selecting the numeric key 4. The second user on the second communication device observes the expression 212 as he hears about the first user's return to work 516.

The message from the first user may take a form of a recorded message such as an annotated voice mail, which may also be reproduced as described above. For text only message, an avatar may be displayed before, after, or along side the message being displayed. If the second communication device is capable of converting the text message to audio, then the primary message part of the text only message may be converted to audio and be played, and an avatar based on the annotation may be displayed as illustrated in FIG. 5. A specific avatar may also be automatically displayed on the second communication device based upon a key word or phrase detected in the message.

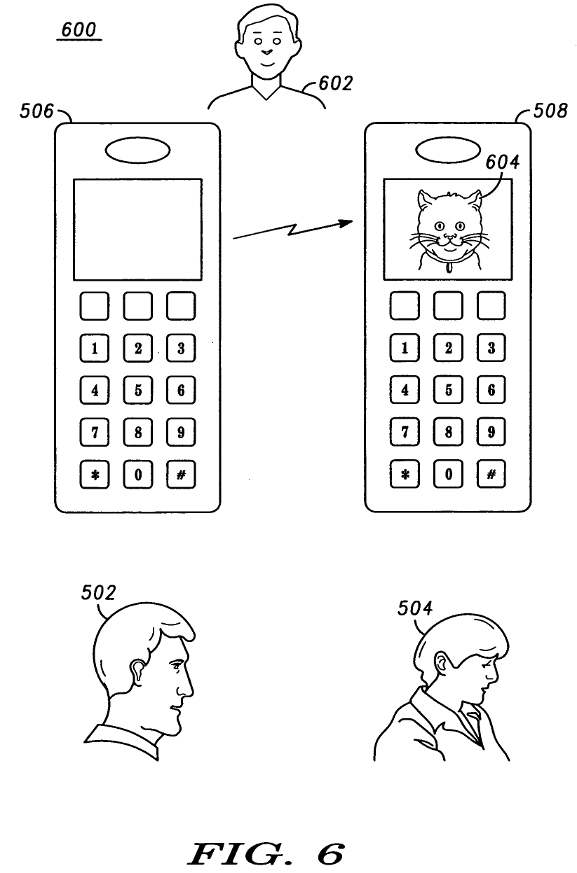

The first user 502 may also attach a specific avatar 602, such as a photographic image of his face, to identify himself as he places a call to the second user 504 from the first communication device 506 as illustrated in FIG. 6. The second user may program the second communication device 508 such that having recognized the caller as the first user, the second communication device may swap the avatar received with another avatar 604 chosen by the second user as the representation of the first user. For example, the photographic image of the first user may be substituted with a cartoon character, which the second user has chosen as the representation of the first user, or with a simple image or image substitute such as emoticon. The image transmitted from the first communication device may be saved in the memory of the second communication device for a later use.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A method in a wireless portable communication device having a display, the method comprising:
receiving a text message;
detecting a textual characteristic of the text message;
annotating the text message with an image based upon the detected textual characteristic;
audibly reproducing the text message; and
displaying the image while audibly reproducing the text message.

2. The method of claim 1, wherein annotating the text message with an image includes selecting an image from a plurality of images being stored in the wireless portable communication device.

3. The method of claim 2, wherein detecting a textual characteristic of the text message includes detecting a pre-selected word.

4. The method of claim 2, wherein detecting a textual characteristic of the text message includes detecting a pre-selected phrase.
